(19) United States
(12) Patent Application Publication
(10) Pub. No.: US 2020/0173819 A1
(43) Pub. Date: Jun. 4, 2020

(54) QUICK CONNECT SENSOR ASSEMBLY

(71) Applicant: SOGEFI AIR & COOLING USA, INC., Rochester Hills, MI (US)

(72) Inventors: Tom KERN, Rochester Hills, MI (US); Fabien SANET, Rochester Hills, MI (US)

(21) Appl. No.: 16/623,138

(22) PCT Filed: Jun. 20, 2018
(86) PCT No.: PCT/US2018/038544

§ 371 Date: Dec. 16, 2019

Related U.S. Application Data
(60) Provisional application No. 62/522,141, filed on Jun. 20, 2017.

(51) Int. Cl. G01D 11/24; G01D 21/02

(52) U.S. Cl. CPC G01D 11/245; G01D 21/02

(57) ABSTRACT

An improved sensor assembly adapted to be received within a port defined by a component housing is provided. The sensor assembly includes a sensor element, a coupling, and a locking housing. The coupling includes a locking member configured for rotationally interlocking the coupling to the port. The locking housing defines a sleeve adapted to extend over the sensor element. The locking housing is adapted to prevent rotational movement of the coupling relative to the port when the coupling is interlocked with the port, thereby preventing disengagement of the coupling from the port.

### CROSS-REFERENCE TO RELATED APPLICATION

The application claims the benefit of U.S. Provisional Application 62/522,141, filed Jun. 20, 2017, the disclosure of which is hereby incorporated by reference in its entirety.

### TECHNICAL FIELD

The present disclosure relates generally toward an improved quick-connect sensor assembly adapted to be received within a port defined by a component housing.

### BACKGROUND

Production sensors are presently designed for mating to metallic, die cast counterparts and require threaded metallic coupling. These couplings are generally made of brass or stainless steel for providing corrosion resistance. Special accommodations are required when the sensors are installed on plastic components that require die inserts necessary to replicate threaded composite or plastic interface and to provide necessary sealing. When mating plastic components to metallic components, variance in thermal expansion of two different materials are known to result in stress failures and sealing that is insufficient to prevent fluid leaking through the interface between the two materials. This has generally been addressed by providing a high number of threads and over-tightening the sensor to the housing. To address the interface, high costs are generated by providing a metallic threaded insert to either the counterpart or the sensor assembly. In addition, when providing a metallic threaded insert for a plastic sensor, manufacturing costs exceed what is considered commercially viable in a competitive marketplace.

Therefore, it would be desirable to develop a sensor assembly capable of quickly mating to a component without undue complexity, particularly when a metallic to plastic interface is required.

### SUMMARY

An improved quick-connect sensor assembly adapted to be received within a port defined by a component housing is provided. The sensor assembly includes a sensor element, a coupling, and a locking housing. The coupling is interconnected with the sensor element and the coupling includes a locking member configured for rotationally interlocking the sensor assembly to the port. The locking housing defines a sleeve adapted to extend over the sensor element. The locking housing is adapted to prevent rotational movement and axial movement of the coupling relative to the port to prevent disengagement of the sensor assembly from the port.

In one embodiment, the locking housing includes a sidewall defining opposing slots. The slots receive a corresponding flange extending from the port, thereby preventing rotational movement of the locking housing. The coupling further includes a preventer integrally attached thereto and disposed in abutting engagement with the component housing when the coupling is rotated into locking engagement with the port. The locking housing includes a housing stop and the preventer includes a coupling stop, wherein the housing stop is disposed in abutting engagement with the coupling stop to prevent rotational movement of the coupling relative to the locking housing.

In another embodiment, the locking housing define a locking housing catch that engages a port catch by snap-fit to provide interlocking engagement between the locking housing and the component housing. The locking housing catch may be disposed upon distal ends of locking arms separated by the opposing slots and the locking arms may be flexible for releasing the housing catch from the port catch.

In a further embodiment, the locking member provides interlocking engagement with the rib extending from the sidewall with a quarter-turn of the coupling relative to the component housing. The locking member includes a helicoidal shape for rotational interlocking the coupling to the port. The coupling defines a seat for receiving a seal to fluidly seal the coupling to the port when the coupling is received by the port. The coupling defines a channel providing fluid access to the sensor element.

A system is also provided. The system includes a component housing having a port and includes a sensor assembly having a sensor element, a coupling, and a locking housing. The port is defined by the component housing and the port includes a sidewall defining a rib. The coupling is interconnected with the sensor element and the coupling is configured to be received by the port. The coupling includes a locking member configured for rotationally interlocking the coupling to the port through lockable engagement with the rib. The locking housing defines a sleeve adapted to extend over the sensor element. The locking housing is adapted to prevent rotational movement of the coupling relative to the port when the coupling is interlocked with the port, thereby preventing disengagement of the coupling from the port.

The quick-connect sensor assembly eliminates complex threads and inserts while providing a quick installation mechanism requiring only a quarter-rotational turn of the coupling relative to the component housing. The quick releasability of the coupling from the port, and the innovative manner in which the locking housing prevents inadvertent rotation of the coupling relative to the port, prevents the inadvertent removal of the sensor assembly, and solves problems previously associated with sensor assemblies in an efficient, low-cost manner.

These and other features and advantages of the present invention will become apparent from the following description of the invention, when viewed in accordance with the accompanying drawings and appended claims.

### BRIEF DESCRIPTION OF THE DRAWINGS

FIG. 1 shows a perspective view of the quick-connect sensor assembly of the present invention installed within the component housing;

FIG. 2 shows a perspective, exploded view of the quick-connect sensor assembly; FIG. 3 shows a side sectional view of a portion of the quick-connect sensor

assembly including the coupling and the sensor element;

FIGS. 4A and 4B show side sectional views of the quick-connect sensor assembly during (A) and after (B) installation within the component housing; and

FIGS. 5A and 5B show the locking housing before (A) and after (B) being secured over the preventer by snap-fit.

### DETAILED DESCRIPTION

Referring to the Figures, a sensor assembly in accordance with one embodiment is illustrated and generally designated 10. The sensor assembly 10 is adapted to be received within a port 12 defined by a component housing 14 (collectively a “system”), the port 12 having an external catch 16 and having an interior sidewall 18 defining a rib 20. The sensor assembly 10 includes a sensor element 22, a coupling 24, and a locking housing 26. Each such feature of the sensor assembly 10 is discussed below.

The sensor element 22 is adapted to directly or indirectly measure a fluid within the component housing 14. The sensor element 22 includes an internal sensor 36, optionally a pressure sensor, temperature sensor, water sensor, fluid level sensor, or compositional sensor. The sensor 36 includes a connector 38 to which a controller or other appropriate electronic devices may be connected. Though only one sensor 36 is shown in FIG. 3, the sensor element 22 can include a plurality of sensors 36.

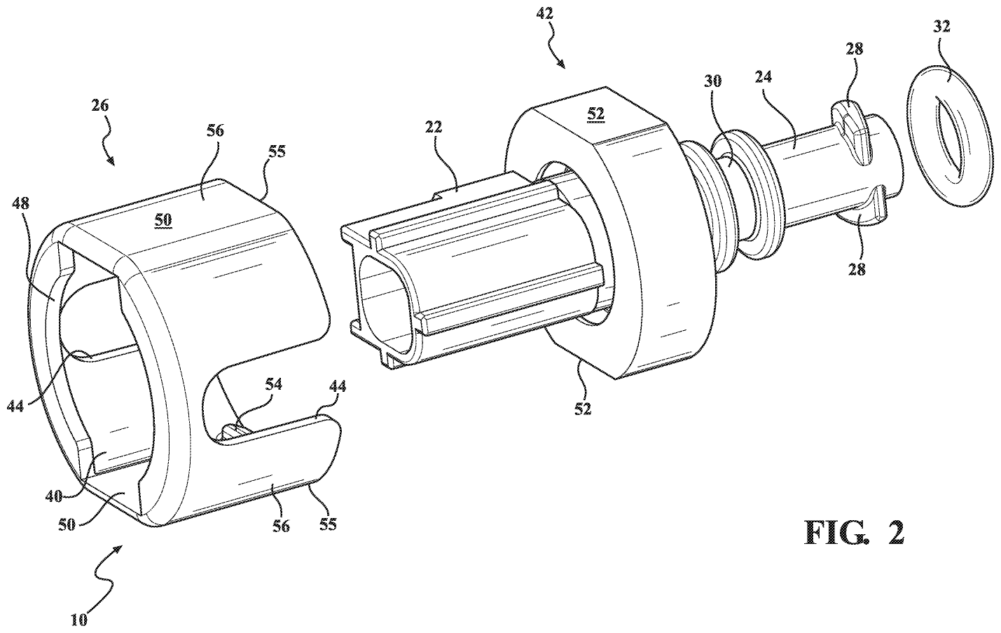

The coupling 24 is generally adapted to secure the sensor assembly 10 to the interior of the port 12 and is rigidly connected to the sensor element 22. The coupling 24 is cylindrical, as shown in FIG. 2, but can include other cross-sectional shapes in other embodiments. The coupling 24 is configured to be received within the port 12 defined by the component housing 14. In various embodiments, the component housing 14 defines a space within which fluid is disposed, and the port 12 is in fluid communication with the fluid disposed within such space. Anything inserted within the port 12 is therefore in fluid communication with the fluid disposed within the space defined by the component housing 14.

The coupling 24 includes a locking member 28 extending radially outward therefrom. The locking member 28 can rotationally interlock the coupling 24 to the port 12 by mechanical engagement with the rib 20. For example, the locking member 28 can include a helical shape 28 that rotatably engage the rib 20, and the rib 20 may include two radially opposed flanges 20 projecting from the sidewall 18 of the port 12. Further by example, the locking member 28 may include radially opposed flanges 28 projecting from a surface of the coupling 24 that engage with the rib 20, where the rib 20 is helical in shape. Still further by example, both the locking member 28 and the rib 20 may be helical in shape. The rib 20 may include a single or a plurality of flanges or helical members and, similarly, the locking member 28 may include a single or a plurality of flanges or helical members. Optionally, the rib 20 or the locking member 28, or both, include cooperable helicoidal members. In several embodiments, the locking member 28 establishes an interlocking engagement with the rib 20 by a fraction of a turn of the coupling 24 relative to the component housing 14 and relative to the port 12. Optionally, the locking member 28 establishes an interlocking engagement with the rib 20 by a half-turn or less, and further optionally by a quarter-turn or less. When the locking member 28 is interlockably engaged with the rib 20, the coupling 24 is thereby locked (alternatively, “secured”, “installed,” or “engaged”) in an inserted position within the port 12.

The coupling 24 defines a seat 30 for receiving a seal 32. The seal is an O-ring 32 in the illustrated embodiment, optionally manufactured of an elastomeric polymer, for example rubber. During installation of the sensor assembly 10 within the port 12, the seal 32 is disposed within the seat 30 and establishes a fluid-tight seal between the sidewall 18 of the port 12 and the coupling 24. The use of the seal 32 has the advantage of eliminating any need for a plurality of threads or other special configurations of threads to seal the coupling 24 to the port 12. The seal 32 provides the advantage of making the depth of insertion of the coupling 24 substantially irrelevant to the establishment of a fluid-tight seal between the sidewall 18 and the coupling 24 to effectively prevent fluid from unintentionally exiting from the port 12.

As shown in FIG. 3, the coupling 24 includes a channel 34 to allow fluid communication between the fluid disposed within the space defined by the component housing 14 and the sensor element 22. The channel 34 may have any of a variety of shapes and configurations, optionally a substantially linear cylindrical opening running along an axis of the coupling 24 and generally centered upon the axis of the coupling 24. The sensor assembly 10 includes a locking housing 26 defining a sleeve 40 adapted to extend over the sensor element 22 and, optionally, a preventer 42, described further below. When the sleeve 40 of the locking housing 26 is extended over the sensor element 22 and the preventer 42, the locking housing 26 prevents rotational movement of the coupling 24 relative to the port 12 and relative to the component housing 14 when the coupling 24 is interlocked with the port 12. The locking housing 26 thereby prevents disengagement of the coupling 24 from the port 12.

The locking housing 26 includes radially opposed slots 44 each configured to receive a flange 46 extending from the component housing 14. When the sleeve 40 of the locking housing 26 is extended over the sensor element 22 while the sensor element 22 is lockably engaged within the port 12, the flanges 46 are by the same action inserted within the slots 44. The disposition of the flanges 46 within the slots 44 serves to prevent rotation of the locking housing 26 relative to the component housing 14. The locking housing 26 includes a locking aperture 48 through which the sensor element 22 may be inserted during installation of the sensor assembly 10 within a component housing 14.

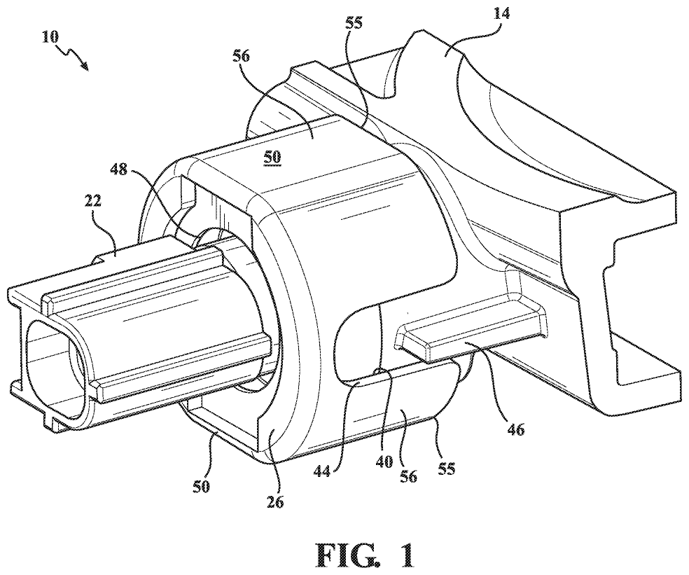

Referring again to FIG. 1, the coupling 24 includes a preventer 42 integrally attached thereto and disposed to be in abutting engagement with the component housing 14 when the coupling 24 is rotated into interlocking engagement with the port 12, as described above. The preventer 42 serves to prevent the sensor assembly 10 from being inserted too far within the port 12 and further provides an opposing force necessary for the coupling 24 to properly establish a secure rotational interlocking within the port 12 mediated by the physical interaction of the rib 20 with the locking member 28, as described above. An internal diameter of an opening defined by the sleeve 40 is generally equivalent to an outer diameter defined by the preventer 42.

The locking housing 26 includes a locking housing stop 50 and the preventer 42 includes a coupling stop 52. These surfaces are generally complimentary to one another. Optionally, the locking housing stop 50 includes a generally planar region of a radially inward-directed surface defined by the sleeve 40 of the locking housing 26 extending in an axial direction, and the coupling stop 52 includes a generally planar region of a radially outward-directed surface of the preventer 42 extending in an axial direction. The locking housing stop 50 is disposed to establish an abutting engagement with the coupling stop 52 to thereby prevent rotational movement of the coupling 24 relative to the locking housing 26. Therefore, the flanges 46, opposing slots 44, coupling stop 52, and locking housing stop 50 function cooperatively to prevent rotation of the coupling 24 relative to the port 12. This prevention of rotation functions to prohibit rotational disengagement of the coupling 24 from the port 12, thereby ensuring that a secure fluid seal remains established by the seal 32 between the coupling 24 and the sidewall 18 of the port 12 and ensuring, therefore, that the sensor assembly 10 does not become detached from the component housing 14.

The locking housing 26 includes a locking housing catch 54 configured to engage the port catch 16 by snap-fit to provide interlocking engagement between the locking housing 26 and the component housing 14. The locking housing catch 54 includes flanges 54 extending into the sleeve 40 from distal ends 55 of locking arms 56. The locking arms 56 are defined by and separated from one another by the opposing slots 44. The port catch 16 includes flanges 16 extending radially outward from a cylindrical region of the component housing 14 partially defining the port 12. When the sensor assembly 10 is installed within the port 12 the locking housing catch 54 is lockably secured over the sensor element 22 through snap-fit engagement mediated by the locking housing catch 54 and the port catch 16, as described further below. This snap-fit engagement is made possible in part by the flexibility imparted to the locking arms 56 by means of the opposing slots 44 and the material composition of the locking housing 26 and locking arms 56. This flexibility of the locking arms 56 enables the locking housing catch 54 to be slipped over the port catch 16 with the application of force to thereby establish a snap-fit. This snap-fit engagement prevents the locking housing 26 from being unintentionally removed from engagement with the component housing 14, which would have the consequence of thereby allowing rotation of the sensor assembly 10 and its potential accidental removal from the component housing 14 as well. The flexibility of the locking arms 56 enables the removal of the locking housing 26 from the component housing 14 by simply pulling the locking arms 56 away from one another (i.e., “outward”) to allow the locking housing catch 54 to bypass the port catch 16 and subsequently pulling the locking housing 26 away from the component housing 14.

The locking housing catch 54 is so configured as to also engage with the preventer 42 by snap-fit so that, prior to installation and after removal of the sensor assembly 10, the locking housing 26 may become and remain securely associated by snap-fit with the sensor assembly 10. This has the advantage of simplifying installation of the sensor assembly 10 because the sensor assembly 10 can be provided to a user as a one-piece unit and, further, can reduce the risk of one or the other of the locking housing 26 or the coupling 24 and sensor element 22 being misplaced or dissociated from the other, which is a situation that would render the remaining element of the sensor assembly 10 at least partially non-functional.

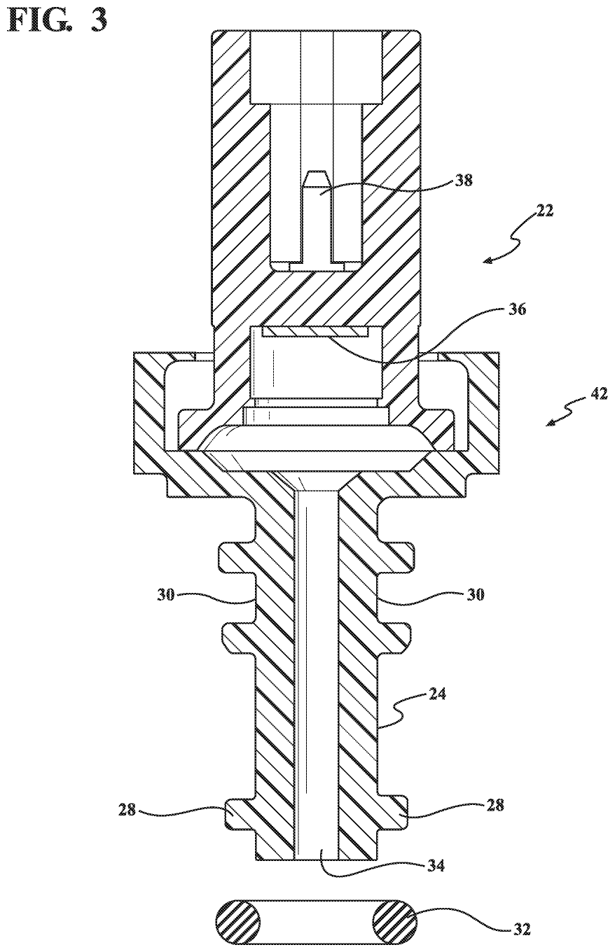

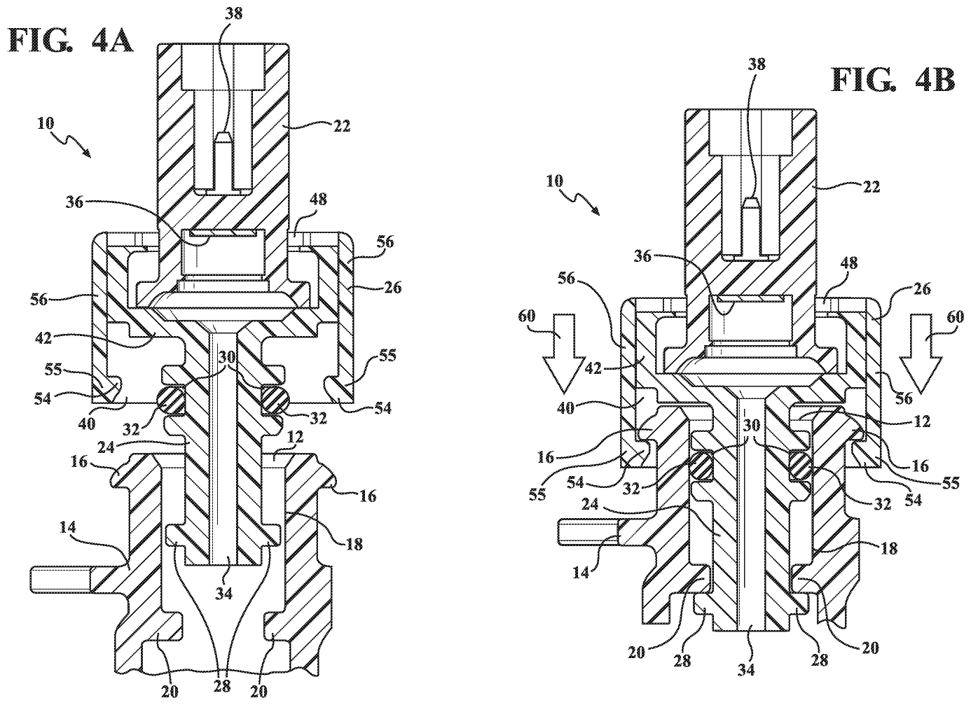

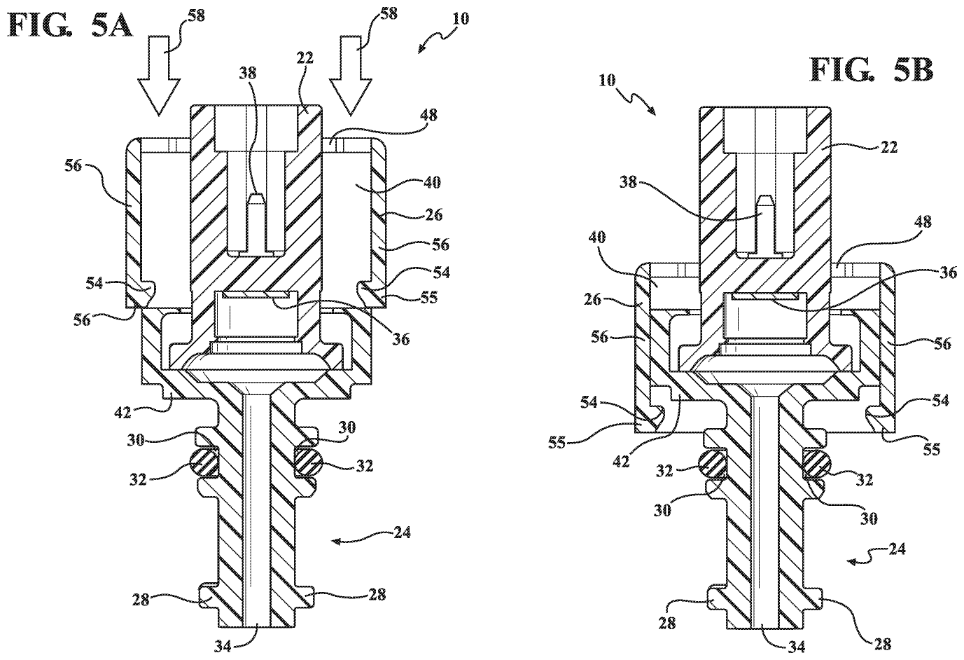

A method of installing the sensor assembly 10 within a component housing 14 can include the following actions. Acquiring the above described sensor assembly 10. Inserting the coupling 24 into the port 12 defined by the component housing 14 until the locking member 28 abuts the rib 20. Rotating the coupling 24 by a fraction of a turn, optionally about 45 degrees, relative to the component housing 14 and port 12 such that the locking member 28 engages with the rib 20. Optionally, positioning the locking member 28 below the rib 20 (as shown in FIG. 4B) by a 45 degree rotation. Aligning the sleeve 40 defined by the locking housing 26 over the preventer 42 such that the locking housing stop 50 aligns with the coupling stop 52 and the sensor element 22 aligns with the locking aperture 48, as generally shown in FIG. 1. Aligning the opposing slots 44 over the flanges 46, as generally shown in FIG. 1. Pushing the locking housing 26 in the direction of the arrows 58 shown in FIG. 5A causing the locking housing catch 54 to impact the preventer 42 causing the locking arms 56 to deflect outward. Pushing the locking housing 26 in the direction of the arrows 58 shown in FIG. 5A until the locking housing catch 54 moves past the preventer 42 causing the locking housing 26 to become secured over the preventer 42 by snap-fit to assume the configuration shown in FIG. 5B. Pushing the locking housing 26 in the direction of the arrows 60 shown in FIG. 4B until the locking housing catch 54 contacts the port catch 16 causing the locking arms 56 to deflect outward. Pushing the locking housing 26 until the locking housing catch 54 bypasses the port catch 16, thereby causing the locking housing catch 54 to secure the locking housing 26 over the port catch 16 by snap-fit and also causing the flanges 46 to be disposed within the opposing slots 44 to prevent rotation of the locking housing 26 relative to the component housing 14 and, further, to prevent the sensor assembly 10 from being rotatably disengaged and withdrawn from the port 12 inadvertently.

A method of removing the sensor assembly 10 from a component housing 14 includes the following actions. Manually deflecting the locking arms 56 outward to a sufficient extent that the locking housing catch 54 may bypass the port catch 16. Moving the locking housing 26 in a direction opposite the arrows 60 shown in FIG. 4B while the locking arms 56 are deflected outward until the locking housing catch 54 bypasses the port catch 16. Rotating the coupling 24 in an appropriate direction such that the locking member 28 disengages from the rib 20, allowing the coupling 24 to be removed from the port 12. Pulling the coupling 24 out of the port 12. Optionally, manually deflecting the locking arms 56 outward to a sufficient extent that the locking housing catch 54 may bypass the preventer 42. Optionally, moving the locking housing 26 in a direction opposite the arrows 58 shown in FIG. 5A while the locking arms 56 are deflected outward until the locking housing catch 54 bypasses the preventer 42.

The various elements of the components of the embodiments of the sensor assembly 10 described above, e.g. the coupling 24, the sensor element 22, and the locking housing 26, may be manufactured of the same or different material(s), such as any one or more of the materials described below. Typically, the sensor assembly 10 is monolithic in construction and homogenous in composition. However, the sensor assembly 10 may comprise multiple components joined together. Moreover, each component may itself comprise a combination of different materials, and thus may not comprise a homogeneous composition throughout. In general, materials suitable for use in or as the sensor assembly 10 (e.g. the coupling 24, the sensor element 22, and the locking housing 26) include metals (e.g. steels, aluminums, alloys, etc.), resins (e.g. thermoset and/or thermoplastic resins), and combinations thereof. However, myriad materials may be used to manufacture the elements of the sensor assembly 10, each typically selected as a function of availability, cost, performance/end use applications etc. For example, the material composition of the sensor assembly 10 may be selected such that the material composition may be compatible with a particular fluid composition relevant to a particular application. Moreover, metals, metal alloys, and resins are not exhaustive of suitable materials that may be used.

The above description relates to general and specific embodiments of the disclosure. However, various alterations and changes can be made without departing from the spirit and broader aspects of the disclosure as defined in the appended claims, which are to be interpreted in accordance with the principles of patent law including the doctrine of equivalents. As such, this disclosure is presented for illustrative purposes and should not be interpreted as an exhaustive description of all embodiments of the disclosure or to limit the scope of the claims to the specific elements illustrated or described in connection with these embodiments. Any reference to elements in the singular, for example, using the articles “a,” “an,” “the,” or “said,” is not to be construed as limiting the element to the singular. The word “diameter” is used to refer generally to that dimension describing the distance spanned by a line connecting a center of a cross-section of an object to the outer perimeter of the object such that two objects sharing a common “diameter” generally at least partially share a common cross-sectional shape.

1. A sensor assembly adapted to be received within a port including a rib extending radially inwardly therefrom, the sensor assembly comprising:
a sensor element joined to a coupling, the coupling including a longitudinal member and a locking member extending radially therefrom, the locking member being configured to rotationally interlock to the rib to prevent withdrawal of the coupling; and
a locking housing defining a sleeve adapted to extend over the sensor element, wherein the sleeve includes opposing lateral slots and is adapted to prevent rotational movement and axial movement of the coupling relative to the port when the locking member is rotationally interlocked with the rib to prevent disengagement of the coupling from the port.

2. The sensor assembly of claim 1 wherein the locking member includes an annular flange to rotationally interlock the coupling to the rib.

3. The sensor assembly of claim 1 wherein the locking member includes a partial thread to rotationally interlock the coupling to the rib.

4. The sensor assembly of claim 1 wherein the coupling defines a channel to provide fluid access to the sensor element.

5. The sensor assembly of claim 1 wherein the opposing lateral slots receive a flange extending from the component housing to prevent rotational movement of the locking housing.

6. The sensor assembly of claim 1 wherein the coupling includes a preventer integrally attached thereto and disposed in abutting engagement with the locking housing.

7. The sensor assembly of claim 1 wherein the sleeve includes a catch configured to engage the port by snap-fit.

8. The sensor assembly of claim 1, wherein the sensor element includes a fluid sensor and is in electrical communication with a controller.

9. The sensor assembly of claim 1 wherein the coupling defines a seat for receiving a seal, the sensor assembly further include an O-ring within the seat.

10. A system comprising:
a component housing defining a port therein, wherein the port includes an interior sidewall defining a rib; and
a sensor assembly including a sensor element and a coupling, the coupling being configured to be to be received by the port and including a locking member configured for rotationally interlocking the coupling to the port through lockable engagement with the rib, the sensor assembly further including a locking housing defining a sleeve adapted to extend over the sensor element, wherein the locking housing is adapted to prevent rotational movement and axial movement of the coupling relative to the port, thereby preventing disengagement of the coupling from the port.

11. The system of claim 10 wherein the locking member includes an annular flange to rotationally interlock the coupling to the rib.

12. The system of claim 10 wherein the locking member includes a partial thread to rotationally interlock the coupling to the rib.

13. The system of claim 10 wherein the coupling defines a channel to provide fluid access to the sensor element.

14. The system of claim 10 wherein the locking housing sleeve includes opposing lateral slots, and wherein the opposing lateral slots each receive a flange extending from the component housing to prevent rotational movement of the locking housing sleeve.

15. A sensor assembly adapted to be received within a port defined by a component housing, wherein the component housing includes an exterior port catch and the port includes an interior sidewall defining a rib, the sensor assembly comprising:
a sensor element;
a coupling, wherein the coupling is interconnected with the sensor element and is configured to be received by the port, the coupling includes a locking member configured for rotation-based lockable engagement with the rib; and
a locking housing defining a sleeve adapted to extend over the sensor element, wherein the locking housing is adapted to prevent rotational movement of the coupling relative to the port and axial movement of the coupling relative to the port when the coupling is interlocked with the port, thereby preventing disengagement of the coupling from the port.

16. The sensor assembly of claim 15 wherein the locking member includes an annular flange to rotationally interlock the coupling to the rib.

17. The sensor assembly of claim 15 wherein the locking member includes a partial thread to rotationally interlock the coupling to the rib.

18. The sensor assembly of claim 15 wherein the coupling defines a longitudinal channel to provide fluid access to the sensor element.

19. The sensor assembly of claim 15 wherein the locking housing sleeve includes opposing lateral slots, and wherein the opposing lateral slots each receive a flange extending from the component housing to prevent rotational movement of the locking housing sleeve.

20. The sensor assembly of claim 15 wherein the coupling defines a seat for receiving a seal, the sensor assembly further include an O-ring within the seat.
